(19) United States
(12) Patent Application Publication
(10) Pub. No.: US 2011/0078233 A1
(43) Pub. Date: Mar. 31, 2011

(54) APPARATUS, SYSTEM, AND METHOD FOR IMPROVED PERFORMANCE OF REAL TIME APPLICATIONS IN INTERMITTENT CONNECTION ENVIRONMENTS

(75) Inventor: Fernando Salazar, Research Triangle Park, NC (US)

(73) Assignee: INTERNATIONAL BUSINESS MACHINES CORPORATION, Armonk, NY (US)

(21) Appl. No.: 12/571,161

(22) Filed: Sep. 30, 2009

(51) Int. Cl. G06F 15/16

(52) U.S. Cl. 709/203; 709/206

(57) ABSTRACT

An apparatus, system, and method are disclosed for distributing events between application instances that are connected by intermittent connections. The application instances are provided with brokers that communicate with each other and their respective application instances according to an interface. The application instances provide events to the brokers, which forward them to the other brokers in the system. If a particular broker cannot be reached, the broker queues the events in a local data store, monitors the connection, and sends them once the connection is reestablished. The broker similarly receives events generated by the application instance associated with the remote broker that could not be communicated while the connection was inactive. As a result, users in the system are provided with a best possible and most complete state of the entire application that is available given the connection statuses in the system at a given time.

### BACKGROUND

1. Field of the Invention

This invention relates to improving the performance of applications that require real time data from multiple sources that are connected by intermittent connections.

2. Description of the Related Art

In an increasingly connected world, many applications operate using internet connections. Certain applications, such as email, due to their nature can operate well even if connectivity is intermittent. For example, a user might compose an email and send it. Since email is not specified to operate in a synchronous or instantaneous fashion, if at that moment the email client cannot connect to the internet, the email client may wait until a connection is established later and then send the email, and receive emails for the user at that time. Thus, even when network availability is intermittent, certain applications may still operate well by opportunistically transferring data when a connection is active.

However, other applications require a continuous connection in order to function well. For example, an instant messaging program (IM) allows multiple users to share text-based messages in real-time. If the connection between the users is lost, IM programs are difficult to use. And if the connection is lost between only a subset of users (for example, users A and B are still connected, users C and D are still connected, but the connection between the two groups is lost), neither subset knows what is happening with the other subset. Once the connection is restored, it is difficult to synchronize the status of the conversation.

Intermittent connections are becoming more and more common. For example, as the number of mobile devices such as phones and netbooks increases, so does the likelihood that users will drift in and out of connectivity with others. In another example, ships at sea may implement local networks and be able to connect with other ships when they are in range. However, ships may move in and out of range with one another.

Since an IM conversation stream may be a valuable resource, it would be helpful to maintain and preserve that stream for future use. In addition, it would be valuable to allow subsets of users to receive updates as to what was discussed among the other subset while connectivity was lost. Other applications, such as online meetings, and screen sharing, may similarly benefit from the ability to create a log or to update users when a connection is restored.

### BRIEF SUMMARY

From the foregoing discussion, it should be apparent that a need exists for an apparatus, system, and method to enable deployment of highly distributed, synchronous collaboration systems where connectivity may be intermittent.

The present invention has been developed in response to the present state of the art, and in particular, in response to the problems and needs in the art that have not yet been fully solved by currently available systems. Accordingly, the present invention has been developed to provide an apparatus, system, and method for distributing events to application instances that are connected with a broker by an intermittent connection.

In one embodiment, the invention is realized as a computer implemented method for a broker to distribute events to application instances that are connected with the broker by an intermittent connection. The method may include the broker receiving events from a first application instance that is connected to the broker by a persistent connection and locally queuing the events. The broker may then check the connectivity status of the intermittent connection between the broker and a second application instance and, when the intermittent connection becomes active, send the locally queued events to the second application instance over the intermittent connection. Similarly, the broker may receive from the second application instance remotely queued events generated by the second application instance when the intermittent connection is active. The second application instance may send these events through a remote broker. The broker sends the remotely queued events to the first application instance connected to it by a persistent connection.

In certain embodiments, certain intermittent connections may be active while others are inactive. The broker may distribute events from the first application instance to those application instances that are connected by an intermittent connection that is presently active while locally queuing events to be sent at a later time for those application instances (such as the second application instance mentioned above) that are not in communication with the broker.

The broker may, in certain embodiments, maintain a distribution list of the remote brokers in the system with which locally queued events and remotely queued events are exchanged. In such embodiments, the broker may distribute the locally queued events to the application instances by sending them to an associated remote broker.

In certain embodiments, the broker may provide an events interface to the persistently connected application instance and to other brokers. The application instance, and the remote brokers, may submit events to the broker and receive them from the broker according to the events interface.

In certain embodiments, a system of brokers includes a broker hub that communicates with the brokers and receives events from the brokers in the system. In such embodiments, the hub broker may manage the exchange of events between the brokers in the system.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system 100 for sharing events between separate application instances;

FIG. 2 is a schematic block diagram illustrating one embodiment of a broker facilitating sharing of events;

FIG. 3 is a schematic block diagram illustrating one embodiment of a system including multiple brokers sharing events;

FIG. 4 is a schematic block diagram illustrating one embodiment of a system including multiple brokers sharing events using a hub broker; and

FIG. 5 is a schematic flow chart diagram illustrating one embodiment of a method for sharing events between separate application instances.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Aspects of the present invention are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

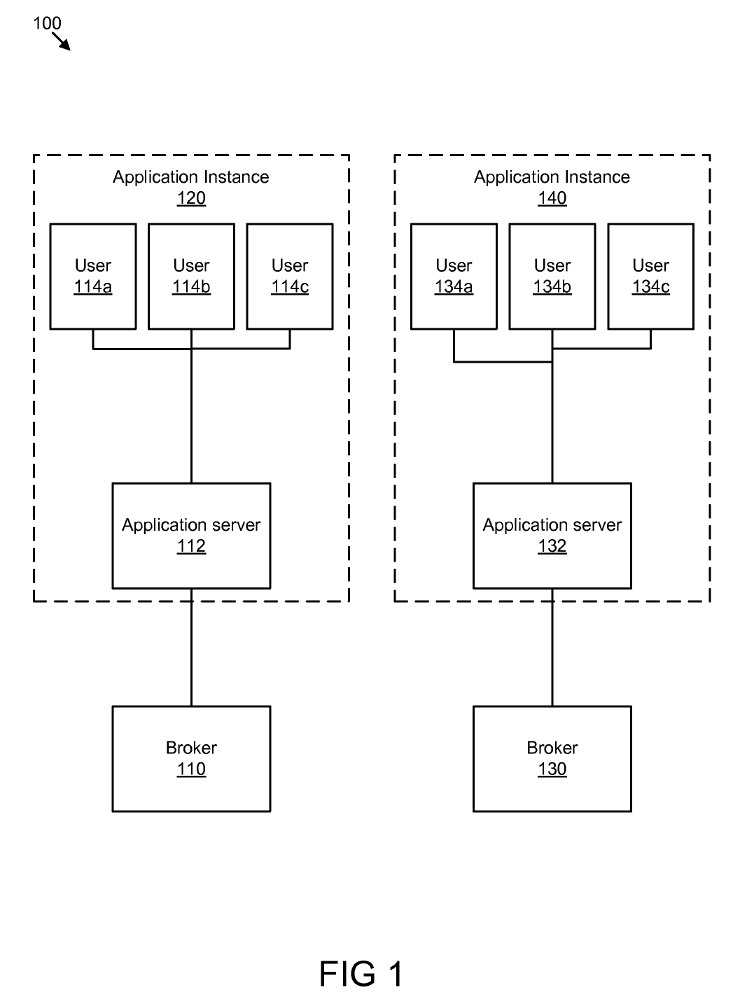

FIG. 1 depicts one embodiment of a system 100 for distributing events to application instances 120 and 140 that are connected with brokers 110 and 130 by intermittent connections. In the depicted embodiment, the system 100 includes one application instance 120 with a corresponding broker 110 and another application instance 140 and a corresponding broker 130. The broker 110 may be referred to as a first broker, and the broker 130 may be referred to as a second broker at points in the application to distinguish between the two brokers. A similar convention may be used to distinguish between the application instance 120 and the application instance 140. However, the system 100 is not limited to any particular number of brokers or application instances; in certain embodiments, the system 100 may include numerous brokers and application instances.

The application instance 120 is depicted as including users 114a-c and application server 112. An application instance, as that term is used in the specification, refers to one or more synchronous application environments that are always available to the users within the application instance through a persistent connection. The application instance corresponds to a single site, or a single mobile unit. A persistent connection is a connection that, when functioning properly, provides continuous connectivity between the users within the application instance and the application server.

For example, an IM application instance 120 may have a server component operating as the application server 112 and client components operating on machines serving the users 114a-c. The application server 112 is local to the users 114a-c and ideally is continuously available to the users 114a-c through a persistent connection. The persistent connection may be, for example, a landline connection or a wireless connection. Thus, the users 114a-c may always be in contact with one another using the application server 112 and the corresponding client components on the individual machines. For example, in an IM application instance 120 the application server 112 may maintain realtime sessions, accept posts from the users 114a-c, send updates to the users 114a-c, and perform other IM server functions. The application server 112 may also interact with a local data store that provides persistent storage of application artifacts such as posts, uploaded files, and others.

The broker 110 is connected to the application instance 120 through a persistent connection. The broker 110 provides necessary services to allow the broker 110 to communicate with the application instance 140 over an intermittent connection. In certain embodiments, the broker 110 communicates with the application instance 140 through the broker 130.

While the broker 110 is depicted as separate from the application instance 120, the two may operate on the same hardware. In other embodiments, the broker 110 may operate on different hardware. The depiction of a separation between the application instance 120 and the broker 110 is to emphasize the logical distinction between the two, is does not imply a physical separation or distinction.

In contrast to the persistent connection used within the application instances 120 and 140, and connecting the application instances 120 and 140 to the respective brokers 110 and 130, the broker 110 communicates with the application instances 140 over an intermittent connection. An intermittent connection is one which, during the course of normal operation, may not provide connectivity between the source and the destination devices. For example, a mobile connection is often an intermittent connection. As noted above, the application instance 120 and broker 110 may be implemented on one ship, while the application instance 140 and broker 130 are implemented on another ship. During the normal course of travel, the intermittent connection between the two ships may be gained and lost and the ships move into and out of range of each other.

In one embodiment, the broker 110 receives events generated by the application instance 120. As used in this application, an event is an encapsulation of a transaction generated by an application instance. In one embodiment, each transaction generates an event such that all transactions that have occurred, as opposed to simply a latest state, can be reproduced using the events. The transaction may be a change such as a change in a screen, a change to a document, additions or deletions, new actions (such as a new IM message), or other occurrence. The events may also be administrative events, such as events creating a new chat room or modifying attributes of an existing chat room. By distributing administrative events, the end result may be a synchronized administrative model. The events may be realized as XML instances, Service Data Objects (SDOs), or implemented using another data structure.

The broker 110 queues the events received from the application instance 120 locally. In one embodiment, the broker 110 has access to a local data store. The broker 110 may queue the events in volatile memory (such as RAM), nonvolatile memory, or both. As used herein, local queuing refers to queuing the events in a device that is connected through a persistent connection such as a bus or a network connection. While the present application describes the broker 110 as queuing events, the term ‘queuing’ is not intended to restrict the broker 110 to using any particular data structure. Nor does the term queue, as used in the application, require that the events be organized in a FIFO sequence. Rather, the term queue is intended to encompass the broader concept of a sequence of data awaiting processing. Thus, lists, queues, tables, or other data structures may be used to queue the events.

In one embodiment, the broker 110 only queues the events generated by the application instance 120 when it is not in communication with each of the other brokers (such as broker 130) in the system 100. For example, if the broker 110 is in communication with each broker in the system 100, the broker 110 may simply send the events to the brokers without queuing them. The broker 110 may queue the events generated by the application instance 120 only when one or more of the other brokers are out of contact. In other embodiments, the broker 110 queues the events regardless of the connectivity status of the intermittent connection.

The broker 110 checks the connectivity status of the intermittent connection between the broker 110 and the application instance 140. In one embodiment, the broker 110 does so by checking the connectivity status of the intermittent connection between the broker 110 and the broker 130. When the connectivity status is active, the broker 110 sends locally queued events over the intermittent connection to the application instance 140. In certain embodiments, the broker 110 sends the events through the broker 130.

In one embodiment, if the intermittent connection with the broker 130 is active, the broker 110 sends the events immediately to the broker 130. If the intermittent connection with the broker 130 is lost, the broker 110 may start track which events are being received by the broker 110 while the intermittent connection is down. The broker 110 may then start monitoring the intermittent connection. Once the intermittent connection is reestablished, the broker 110 sends the events received from the application server 112 while the intermittent connection was down. As mentioned above, the broker 110 may also start sending the events in real time while the connection is active. The broker 110 may also note which events it has transferred to the broker 130 to ensure that the events are not retransmitted. In embodiments with multiple brokers, the broker 110 may send events in real time to those brokers that have an active connection with the broker 110, queue events for those brokers that are not connected to the broker 110, and track which events have and have not been sent for the multiple brokers.

The broker 110 may also receive requests that have been queued by a remote broker (such as broker 130). The broker 110 may receive these remotely queued events when the connection status between the broker 110 and the broker 130 is active. The broker 130 may queue events generated by the application instance 140 and send those events to the broker 110 in a manner similar to that described above. The broker 110 may receive the remotely queued events and send them to the application instance 120.

In certain embodiments, the events include metadata about the transactions that triggered the events. The metadata may allow the broker 110 to determine a context for the events; for example, the metadata may include the time at which the event was generated. The broker 110 may use the time metadata to interleave the events that occurred on the application instance 140 with those that occurred on the application instance 120. The event metadata may similarly include the necessary information to allow the application instance 140 to realize the event in its own local environment as if it were entered by a local user 134a-c.

In certain embodiments, the broker 110 maintains a distribution list of the brokers (such as brokers 130) in the system 100. The distribution list may be implemented as a flat file, database table, or other data structure known in the art. The distribution list may provide a complete list of brokers in the system 100 as well as information, such as addresses, that allow the broker 110 to communicate with the other brokers.

In certain embodiments, the broker 110 provides an event interface to the first application instance 120. For example, the broker 110 may provide an application programming interface (API) specifying the manner in which events are communicated with the broker 110. In certain embodiments, the application instance 120 is provided with a plug-in that allows the application instance 120 to send events to, and receive events from, the broker 110. For example, an IM application instance 120 may be outfitted with a plug-in that generates events each time a new entry is entered in the text box by one of the users 114a-c. Similarly, the plug-in may receive events from the IM application instance 140, appropriately unpack the event, and insert the text entry into the chat record at an appropriate point. The plug-in may be installed at the application server 112.

The broker 110 may thus accept events from one or more application instances 120 that are persistently connected to the broker 110. As events are received from the application instances (such as application instance 120), the broker 110 may either distribute the events directly to connected brokers, or queue the events for later delivery. To facilitate later delivery, the broker 110 may continually check for network availability of the various brokers in the system, and deliver queued events as needed. The broker 110 may also receive events from the brokers in the system and transmit them to an appropriate application instance 120.

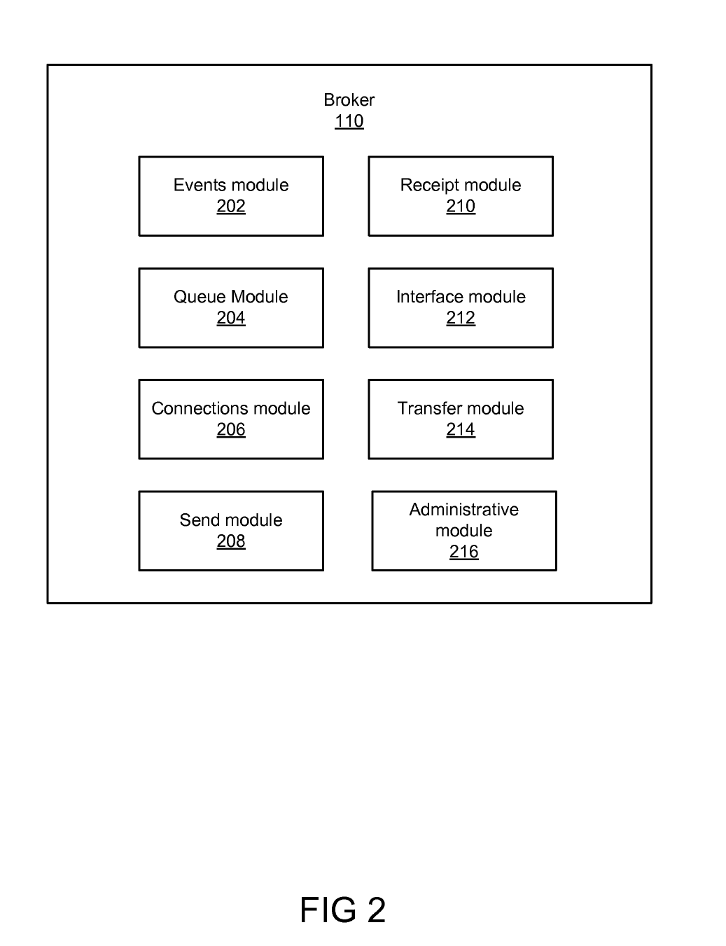

FIG. 2 shows one embodiment of a broker 110. The broker 110 includes, in the depicted embodiment, an events module 202, a queue module 204, a connections module 206, a send module 208, a receipt module 210, an interface module 212, and a transfer module 214.

In one embodiment, the events module 202 receives events from the application instances that are connected to the broker 110 by a persistent connection. As noted above, the application instances may be configured with a plug-in to allow the application instances to communicate the events to the broker 110. The events module 202 may also be configured such that it receives only certain types of events from the local application instance. In one embodiment, plug-in defines which sorts of transactions generate events sent to the events module 202. For example, in an IM application instance, the IM application instance may be configured such that only new chat lines trigger generation of events. Other transactions, such as changes to the appearance of the local IM application instance, may not generate events. In other embodiments, only some chat rooms may be designated as distributed (and thus generating events), while others are deemed local and do not generate events that are sent to the broker 110.

The queue module 204 locally queues the events received from the application instance for the broker 110. The queue module 204 may also be configured to track which brokers in the system have received which events; thus, the queue module 204 may maintain queues for each of the brokers in the system and track which brokers have received which events. The queue module 204 may also be configured to ensure that the brokers do not receive duplicates of the events generated by the application instance connected to the broker.

The connections module 206 checks the connectivity status of the intermittent connection between the broker 110 and the remote application instances. As used herein, an intermittent connection is a communications connection allowing data transfer which system designers know will have periods where the connection is active and periods where the connection is inactive. For example, an intermittent connection may be a mobile connection where various devices communicating over the mobile connection may move in and out of range of each other as part of normal operations. In one embodiment, the connections module 206 does so by monitoring the connectivity status of the intermittent connection between the broker 110 and the other brokers in the system. At a particular time, the intermittent connections may be either active, in which case events may be transferred over the intermittent connection, or inactive, in which case events cannot be transferred. The connections module 206 may use a distribution list to determine which brokers are in the system, and thus, which intermittent connections to monitor.

The connections module 206 may determine whether the intermittent connection is active or inactive using a variety of techniques. In one embodiment, the connections module 206 may ping the remote brokers to determine whether or not the particular brokers are reachable. Based on whether or not the connections module 206 receives a response, the connections module 206 may determine whether the intermittent connection is active or inactive. Other approaches known to those of skill in the art for determining network status may also be used.

The connections module 206 may also be responsible for maintaining the connections between the broker 110 and the other brokers in the system. The connections module 206 may also be responsible for maintaining the connection between the broker 110 and the locally attached application instance. The connections module 206 may also monitor the health of the various connections with the broker 110.

The broker 110 may also include a send module 208. The send module 208 sends the events generated by the persistently connected application instance that have been locally queued by the broker 110 to the remote application instances when the connection status between the broker 110 and the remote application instances becomes active. The send module 208 may send events immediately while the intermittent connection between the broker 110 and the relevant application instance is active.

In certain embodiments, the send module 208 may include metadata as part of the events. For example, the send module 208 may specify the nature of the application instance (i.e., an IM application), provide information about the originating broker 110, and provide information about the nature of the event (i.e., what the event represents and how it should be handled).

In certain embodiments, the send module 208 may also assign priorities to particular events. Thus, certain events may be transferred before others, or the send module 208 may include instructions directing the receiving entity (such as a remote broker) to process particular events before others. For example, events corresponding to real-time updates (such as a new IM post or a screen-sharing session) may be given priority over events related to longer-lived and less critical operations such as a file upload.

In certain embodiments, the send module 208 broadcasts the locally queued events to all remotely connected brokers. In other embodiments, the send module 208 sends specific sets of locally queued events to particular remote brokers.

The queue module 204 may queue events received from the first application instance if the connection module 206 determines that at least one of the remote application instances are not connected by an intermittent connection that is active. In other embodiments, the queue module 204 queues all events received from the first application instance regardless of the status of the intermittent connections. In such an embodiment, the send module 208 may track which remote application instance has received which events, and send only the events that have not been received by the remote application instance when there is an active intermittent connection.

In certain embodiments, the send module 208 receives information concerning the status of the intermittent connections from the connection module 206. The send module 208 may use this status information to track the event history (i.e., which events have been sent and which have not been sent) for the various remote application instances. In certain embodiments, the remote application instances (or the brokers to which they are connected) generate response messages when they receive an event. In such an embodiment, the send module 208 may base its determinations as to which remote application instances have received which events on the response messages. Such an embodiment may ensure that the events sent were successfully received, and allow the send module 208 to resend events that were sent, but not received by the remote application instances.

The broker 110 may also include a receipt module 210. The receipt module 210 receives events generated by other application instances connected to remote brokers. The receipt module 210 may receive these from the remote broker when the intermittent connection is active. In certain embodiments, the remote broker will have determined which events were generated by the remote application instance while the connection was inactive, remotely queued these events, and then send them to the receipt module 210 when the connection becomes active again. While the intermittent connection is active, the receipt module 210 may receive events from the remote broker as they are generated by the remote application instance, with the queuing process beginning again on the remote broker once the intermittent connection becomes inactive.

The transfer module 214 sends the remotely queued events received by the receipt module 210 to the application instance that is persistently connected to the broker 110. The application instance, as noted above, may include a plug-in component for receiving the remotely queued events, unpacking them, and inserting them appropriately into the application instance data.

The broker 110 may also include an interface module 212. The interface module 212 may provide an events interface to the local application instance. The events module 202 may receive the events from the local application instance in accordance with the interface established by the interface module 212. The receipt module 210 may similarly receive the remotely queued events sent by remote brokers according to the interface established by the interface module 212. The transfer module 214 may also send remotely queued events to the application instance as specified by the interface module 212. In one embodiment, the interface module 212 provides an API to facilitate sharing events and information between the broker 110 and the remote brokers in the system and between the broker 110 and the local application instance.

The administrative module 216 may provide users of the system with access to administrative aspects of the broker 110. For example, the user may use the administrative module 216 to provide information on remote brokers and the intermittent connections, information about the application instances that will be supported by the broker 110, and other administrative functions. In one embodiment, the administrative module 216 provides a remote control interface that allows the management of the settings by a range of other components.

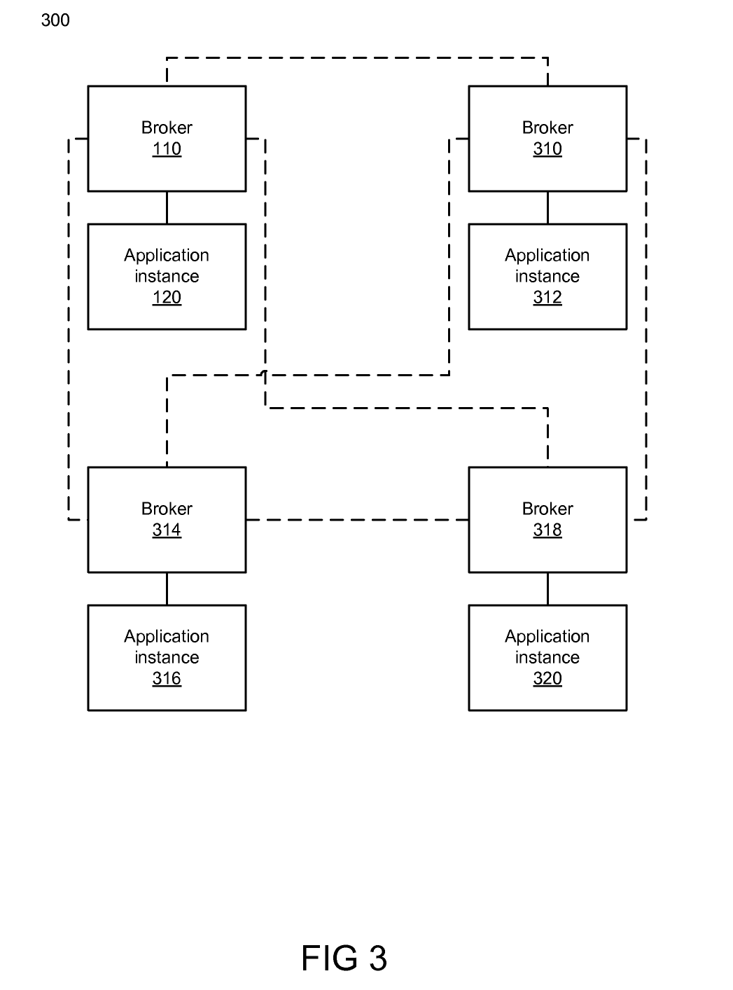

FIG. 3 shows one embodiment of a system 300 for distributing events to application instances that are connected with brokers by intermittent connections. The system 300 includes a broker 110 and a related application instance 120, as well as brokers 310, 314, and 318, with related application instances 312, 316, and 320 respectively. In the system 300, persistent connections between brokers and their respective application instances are represented by solid lines. Intermittent connections between brokers are represented by dashed lines.

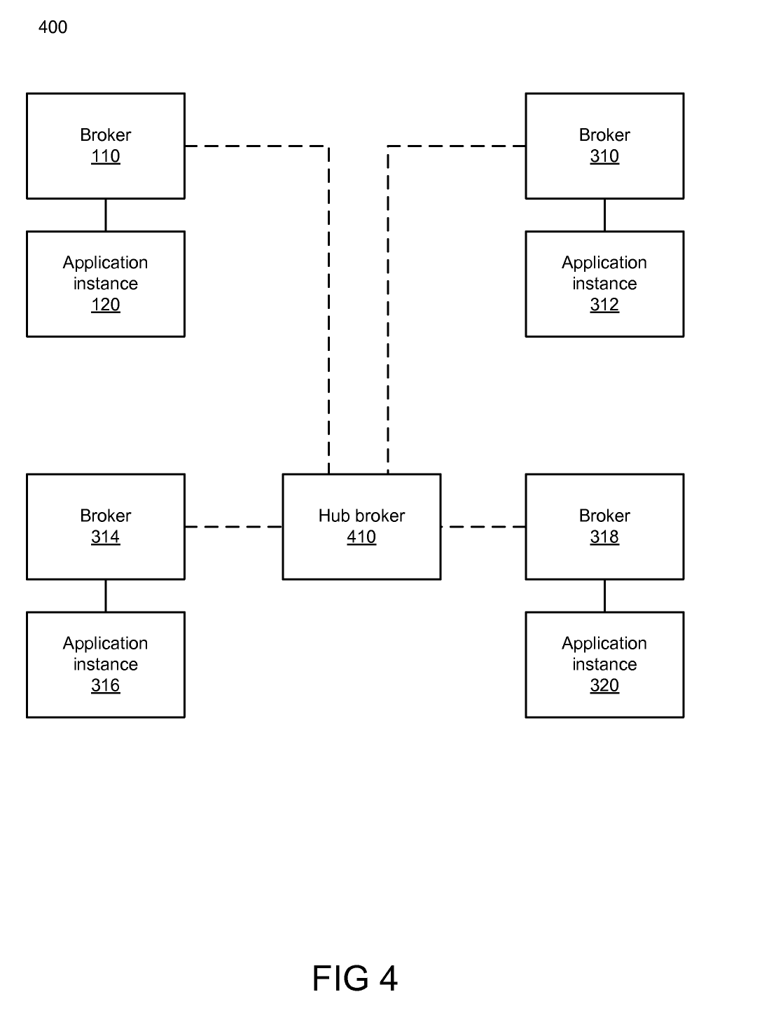

In one embodiment, the brokers in the system 300 create a mesh network, with each broker maintaining a connection with every other broker that is available. In other embodiments, the brokers may be configured in a mesh network and also connect to a hub broker, as shown in FIG. 4. In still other embodiments, a subset of brokers may form a mesh network, and each subset connects to the hub broker.

The brokers in the system 300 may share events generated by the application instances 120 in the system 300. For example, the broker 110 may include an events module 202 for receiving events from the application instance 120, a queue module 204 for locally queuing the events received from the application instance 120, and a connections module 206 for checking the connectivity of the intermittent connection between the broker 110 and other brokers in the system 300, such as broker 310. A send module 208 of the broker 110 may send the locally queued events generated by the local application instance 120 over the intermittent connection between the broker 110 and the other brokers when the connection status of the particular intermittent connection is active. Similarly, a receipt module 210 may receive remotely queued events from other brokers over the intermittent connection when the connection status between the broker 110 and the other brokers is active. The other brokers in the system 300 may have identical modules for performing these same operations.

The brokers in the system 300 may each maintain distribution lists that provide connection information concerning the other brokers in the system. For example, the distribution lists may include each remote broker in the system (for example, the distribution list of broker 110 may indicate that there are brokers 314, 310, and 318 in the system 300), addresses for the broker, and information concerning the intermittent connection between the brokers. Other approaches to enabling communications connections between the brokers may also be used.

For example, the intermittent connection between the broker 110 and the broker 310 may have been inactive for a period of 20 minutes, while the intermittent connection between the broker 110 and the brokers 314 and 318 have been active. During the 20 minute period, the broker 110 may send events generated by the application instance 120 to the brokers 314 and 318 in real-time; that is, since the intermittent connection is active, the broker 110 may send the events to the brokers 314 and 318 without undue delay. Thus, the respective application instances 316 and 320 receive the events in real-time.

Since the intermittent connection between the broker 110 and the broker 310 has been inactive, during the 20 minute period that the connection is inactive the broker 110 may be locally queuing the events generated by the application instance 120 in addition to sending those events to the brokers 314 and 318. The broker 110 may also be continuously monitoring the connection status of the intermittent connection between the broker 110 and the broker 310. When the connection between the broker 110 and the broker 310 is reestablished, the broker 110 sends the events which it has queued for the application instance 120 during the 20 minute period to the brokers 310.

Since the broker 310 has been out of communication with the broker 110 for the 20 minute period as well, the broker 310 may have similarly been queuing events for the application instance 312. When the connection is reestablished, the broker 310 sends these queued events (remotely queued events from the perspective of the broker 110) to the broker 110. The broker 110 and 310 may then send these received events to their respective application instances 120, which can present them to the users.

In one embodiment, one broker and a corresponding application instance is implemented on a ship. In other embodiments, the broker and corresponding application instance may be realized on a mobile device such as a cell phone or laptop. The intermittent connection between the brokers may represent a mobile connection between the devices that support the broker/application instance pairings. As the brokers move in and out of communication with one another, each broker presents the “best possible picture” available at a given time based on the brokers connections. To the extent possible, the system 300 updates the picture to provide improved synchronization in an inherently asynchronous environment.

FIG. 4 shows one embodiment of a system 400 for distributing events between brokers. FIG. 4 includes brokers and application instances connected by persistent connections, as described above. FIG. 4 also includes a hub broker 410. In certain embodiments, such as that shown in FIG. 4, the brokers communicate with each other (and thus with the application instances in the system 400) through the hub broker 410.

In certain embodiments, the hub broker connects to one or more of the brokers in the system 400, and each broker receives remotely queued events from the other brokers in the system 400 through the hub broker 410. Similarly, each broker in the system 400 may send locally queued events from the locally attached application instance to the other brokers in the system through the hub broker 410.

The hub broker 410 may be configured such that it only communicates with brokers in the system (such as brokers 110, 310, 314, and 318) and does not communicate directly with any application instance. The hub broker 410 may provide the functionality to distribute the events appropriately. In such an embodiment, the broker 110 may send events to the hub broker 410 when the communications connection between the broker 110 and the hub broker 410 is active. When the connection is inactive, the broker 110 may queue the events locally and monitor the status of the connection. Once the intermittent connection is active again, the broker 110 sends the locally queued events to the hub broker 410 and receives remotely queued events from the hub broker 410.

In such embodiments, the hub broker 410 may be configured with the necessary logic and storage to manage receipt and distribution of events throughout the system 400. The hub broker 410 may be responsible for tracking the “picture” each broker has of the application instance and determining which events need to be sent to each broker to provide it with the best possible picture. For example, the hub broker 410 may be responsible for queuing events received from the brokers in local storage, monitoring the connection status of the hub broker 410 with each broker in the system 400, and compiling and sending the events that a particular broker 410 did not receive while the intermittent connection with the hub broker 410 was inactive. The hub broker 410 may also maintain the distribution list; in such embodiments, connections for the individual brokers may be simplified since they need only connect with the hub broker 410, and the underlying complexity of the system 400 is hidden.

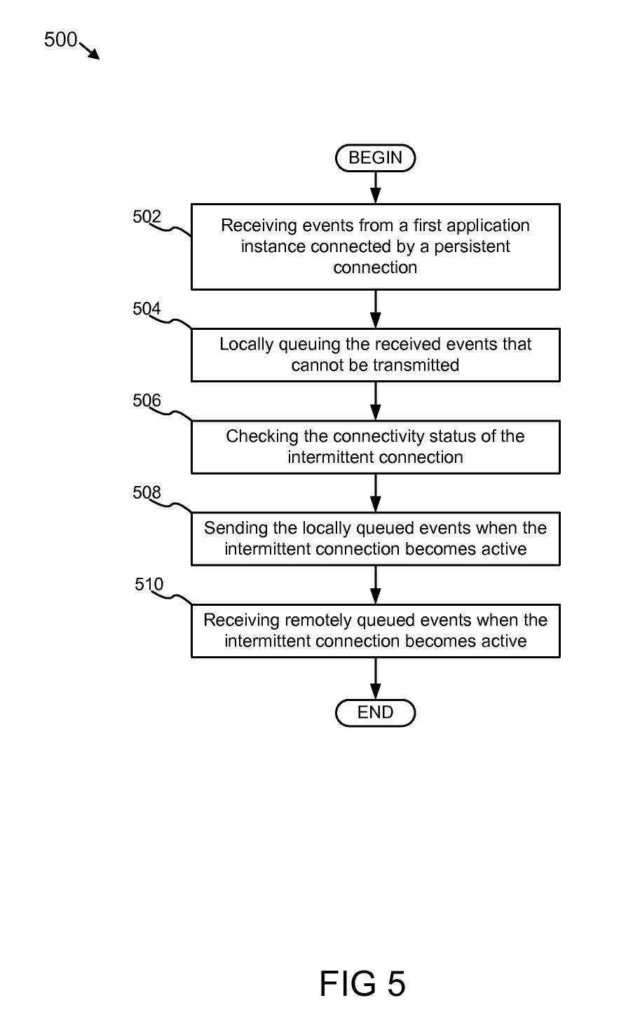

FIG. 5 shows one embodiment of a method 500 for distributing events generated by an application instance connected to a broker. In one embodiment, the method includes the broker receiving 502 events from a first application instance that is connected to the broker by a persistent connection. The broker locally queues 504 the received events generated by the application instance that cannot be transmitted. For example, the intermittent connection may be inactive, thus preventing the broker from successfully transmitting the events to remote brokers.

The method 500 may also include the broker checking 506 the connectivity status of the intermittent connection. As noted above, the intermittent connection may be a mobile connection. The broker may check the intermittent connection between the broker and the remote broker at predefined intervals.

The broker may then send 508 the locally queued events to the remote broker when the intermittent connection becomes active. In certain embodiments, only those locally queued events that have not been successfully transmitted previously over the intermittent connection are sent when the intermittent connection becomes active. Similarly, the broker may receive 510, from the remote broker, remotely queued events that the broker has not successfully received previously over the intermittent connection when the intermittent connection becomes active. The remotely queued events, as noted above, are generated by an application instance that is persistently connected to the remote broker.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer implemented method for a broker to distribute events to application instances that are connected with the broker by an intermittent connection, the method comprising:
receiving events from a first application instance that is connected to the broker by a persistent connection;
locally queuing the events received from the first application instance;
checking a connectivity status of the intermittent connection between the broker and a second application instance; and
sending the locally queued events to the second application instance over the intermittent connection in response to the connection status between the broker and the second application instance being active.

2. The method of claim 1, further comprising receiving, over the intermittent connection and in response to the connection status between the broker and the second application instance being active, remotely queued events generated by the second application instance.

3. The method of claim 2, further comprising sending the remotely queued events to the first application instance.

4. The method of claim 1, further comprising distributing the events from the first application instance to a third application instance that is connected to the broker by an active intermittent connection.

5. The method of claim 1, wherein the locally queued events are sent to the second application instance through a remote broker that is persistently connected with the second application instance, and wherein the remotely queued events are received from the second application instance through the remote broker.

6. The method of claim 5, further comprising maintaining a distribution list of one or more remote brokers with which locally queued events and remotely queued events are exchanged.

7. The method of claim 5, wherein distributing events to the second application instance comprises sending the locally queued events to the remote broker, the remote broker distributing the locally queued events to the second application instance.

8. The method of claim 1, further comprising the broker providing an events interface to the first application instance, and wherein the received events are submitted by the first application instance to the broker according to the events interface.

9. The method of claim 8, further comprising sending the remotely queued events to the first application instance according to the events interface.

10. A broker to distribute events to application instances that are connected with the broker by an intermittent connection, the broker comprising:
an events module for receiving events from a first application instance that is connected to the broker by a persistent connection;
a queue module for locally queuing the events received from the first application instance;
a connections module for checking a connectivity status of the intermittent connection between the broker and a second application instance; and
a send module for sending the locally queued events to the second application instance over the intermittent connection in response to the connection status between the broker and the second application instance being active.

11. The broker of claim 10, further comprising a receipt module for receiving, over the intermittent connection and in response to the connection status between the broker and the second application instance being active, remotely queued events generated by the second application instance.

12. The broker of claim 10, further comprising an interface module that provides an events interface to the first application instance, and wherein the events module receives events from the first application instance that are submitted according to the events interface.

13. The broker of claim 10, further comprising a transfer module that sends the remotely queued events to the first application instance according to the events interface.

14. A system to distribute events to application instances that are connected with one or more brokers by intermittent connections, the system comprising:
a first broker connected to a first application instance by a first persistent connection, the first broker comprising:
an events module for receiving events from the first application instance;
a queue module for locally queuing the events received from the first application instance;
a connections module for checking a connectivity status of an intermittent connection between the first broker and a second broker;
a send module for sending the locally queued events to the second broker over the intermittent connection in response to the connection status between the first broker and the second broker being active;
a receipt module for receiving remotely queued events from the second broker over the intermittent connection in response to the connection status between the first broker and the second broker being active;
the intermittent connection connecting the first broker and the second broker; and
the second broker connected to a second application instance by a second persistent connection, the second broker comprising:
an events module for receiving events from the second application instance;
a queue module for locally queuing the events received from the second application instance;
a connections module for checking a connectivity status of an intermittent connection between the first broker and a second broker;
a send module for sending the locally queued events to the first broker over the intermittent connection in response to the connection status between the first broker and the second broker being active;
a receipt module for receiving remotely queued events from the first broker over the intermittent connection in response to the connection status between the first broker and the second broker being active.

15. The system of claim 14, further comprising one or more additional brokers that communicate with the first broker and the second broker over the intermittent connection.

16. The system of claim 15, wherein each broker in the system maintains a distribution list of other brokers with which events are exchanged.

17. The system of claim 14, further comprising a hub broker that is connected to one or more brokers, and wherein each broker receives remotely queued events from the other brokers through the hub broker, and wherein each broker sends locally queued events through the hub broker.

18. The system of claim 14, wherein each broker in the system further comprises a transfer module that sends the remotely queued events to the first application instance according to the events interface.

19. The system of claim 14, wherein each broker in the system further comprises a storage module for storing the events received from the first application instance in a data store that is locally attached to the broker.

20. A computer program product stored on a computer readable storage medium and comprising operations for a broker to distribute events generated by an application instance connected to the broker by a persistent connection with a remote broker connected to the broker by a mobile connection, the operations comprising:
the broker receiving events from the first application instance that is connected to the broker by the persistent connection;
the broker locally queuing those events received from the first application instance that have not been successfully transmitted to the remote broker over the mobile connection;
the broker checking a connectivity status of the mobile connection between the broker and a remote broker at predefined intervals;
the broker sending, to the remote broker, the locally queued events that have not been successfully transmitted previously over the mobile connection in response to the connection status between the broker and the remote broker being active; and
the broker receiving, from the remote broker, remotely queued events that the broker had not successfully received previously over the mobile connection in response to the connection status between the broker and the remote broker being active.
